(19) United States
(12) Patent Application Publication
(10) Pub. No.: US 2026/0206688 A1
(43) Pub. Date: Jul. 23, 2026

(54) Determining a custom light protocol for illuminating plants of multiple varieties under the same light conditions

(71) Applicant: SIGNIFY HOLDING B.V., EINDHOVEN (NL)

(72) Inventors: JAEHAN KOH, CHESTNUT HILL, MA (US); MATHAN KUMAR GOPALSAMY, MEDFORD, MA (US); PETER DEIXLER, ARLINGTON, MA (US)

(21) Appl. No.: 19/143,999

(22) PCT Filed: Dec. 20, 2023
(86) PCT No.: PCT/EP2023/086811

§ 371 Date: Jun. 27, 2025

Related U.S. Application Data
(60) Provisional application No. 63/436,925, filed on Jan. 4, 2023.

(30) Foreign Application Priority Data
Feb. 1, 2023 (EP) 23154400.8

(51) Int. Cl. A01G 7/04; H05B 47/115

(52) U.S. Cl. CPC A01G 7/045; H05B 47/115

(57) ABSTRACT

A method of controlling a light source in a plant growing environment comprises identifying multiple plant varieties (30,40) of plants (33,34,41) to be illuminated simultaneously by a light source (22), determining a custom light protocol for illuminating the plants of the multiple plant varieties under the same light conditions based on light protocols and/or light sensitivities associated with each of the multiple plant varieties, and controlling the light source according to the custom light protocol. The custom light protocol specifies light conditions in terms of at least one of intensity, spectrum, polarization, directivity and timing of light.

### FIELD OF THE INVENTION

The invention relates to a method of controlling a light source in a plant growing environment.

The invention further relates to a computer program product enabling a computer system to perform such a method.

The invention also relates to a controller for controlling a light source in a plant growing environment.

### BACKGROUND OF THE INVENTION

Cannabis is one of the highest value crops in the world. Though some growers prefer growing one cultivar (i.e. one variety of Cannabis) in one grow site, growing multiple cultivars at once can be beneficial in multiple ways: first, by growing a variety of cultivars, growers can get different flavors, scents, effects, and terpene profiles, etc. Second, if different cultivars are grown in the same room, it often results in increased yield. Besides, growers can master the cultivation of different strains of Cannabis faster.

For these reasons, a Cannabis farmer typically cultivates several cultivars in each grow room. The actual number of cultivars and number of plants per cultivar grown in a grow room vary across production batches and are influenced by expected demand of end-use applications (e.g., a farmer may want to produce more of recreational varieties during tourist seasons and may want to produce more medicinal varieties during flu season).

For determining the light protocol for controlling grow lighting devices, growers typically utilize a cultivation map. The cultivation map includes varying number of cultivars and the exact start and end of a cultivar on a growing table. This cultivation map varies from production cycle to cycle. As a result, grow light sources will see two different conditions under them: all plants under a light source belong to the same cultivar; or plants under a light source belong to multiple, typically two, different cultivars.

The need to have different spectra for growing different plants and/or for different growth stages of plants is known. For example, US 2020/0344965 A1 discloses a gardening apparatus which includes a fluid reservoir and a plant support disposed on the reservoir. The support is adapted for receiving one or more modular plant inserts, and can define a flow structure for channeling fluid to each insert. A light assembly is adapted to generate a spectrum of light for growth of plants from the inserts.

US2020/0344965 A1 further discloses that unlike other, more traditional indoor gardening systems, the gardening apparatus can be automated and adapted for each type of plant or selected mixture of plants that is grown, using identifying indicia to determine the plant type or types, and a plant-specific recipe or algorithm to determine appropriate irrigation and light cycles. However, if a single light source illuminates plants of multiple plant varieties, then it is not sufficient to use plant-specific recipes or algorithms.

### SUMMARY OF THE INVENTION

It is a first object of the invention to provide a method of controlling a light source, which makes it possible to grow plants of multiple plant varieties in a desired manner even when they are illuminated by the same light source.

It is a second object of the invention to provide a controller for controlling a light source, which makes it possible to grow plants of multiple plant varieties in a desired manner even when they are illuminated by the same light source.

In a first aspect of the invention, a method of controlling a light source in a plant growing environment comprises identifying multiple plant varieties of plants to be illuminated simultaneously by a light source, determining a custom light protocol for illuminating said plants of said multiple plant varieties under the same light conditions, based on light protocols and/or light sensitivities associated with each of said multiple plant varieties, said custom light protocol specifying light conditions in terms of at least one of intensity, spectrum, polarization, directivity and timing of light, and controlling said light source according to said custom light protocol. Said method may be performed by software running on a programmable device. This software may be provided as a computer program product.

With this method, a custom light protocol may be determined that is suited to each plant variety even though they are mixed in the same grow environment and illuminated by the same light source, e.g. same LED. Thus, multiple plant varieties may be grown in a desired manner, e.g. to attempt to achieve a KPI of growth or plant properties, even when they are illuminated by the same light source.

The method may be used by growers to achieve a uniform height of plants for different plant varieties, e.g. different cultivars of Cannabis, present on a grow shelf and to achieve precision agriculture. The method may be used multiple times for different light sources which simultaneously illuminate plants of multiple plant varieties. Standard (non-custom) light protocols may be used for light sources which only illuminate plants of one plant variety at a time.

The multiple plant varieties may include multiple varieties of the same plant species, e.g. multiple cultivars of Cannabis, and/or multiple varieties of different plant species. The multiple cultivars of Cannabis may include Cannabis Sativa, Cannabis Sativa L. and/or or Incica, for example. The method may not only be used for Cannabis plants but also for other plant types, e.g. tomato and cucumber. A light protocol is also referred to as a light recipe.

By determining, e.g. learning, the light sensitivities associated with a plant variety, it can be determined how changing the light settings will affect the growth of this plant variety. The light sensitivity is related to the duration of bright light. The sensitive plant needs bright light up to eight hours a day. It can even tolerate some direct sunlight. If it does not get enough sunlight, the leaves may close up and it will not produce blooms.

Said method may comprise determining said custom light protocol by determining a common light protocol based on each of said light protocols and/or light sensitivities associated with said multiple plant varieties, said common light protocol specifying light conditions in terms of at least one of intensity, spectrum, polarization, directivity and timing of light and said common light protocol stimulating growth and/or improving the health of all of said multiple plant varieties, and determining a variety-specific light protocol based on at least one of said light protocols associated with said multiple plant varieties, said variety-specific light protocol specifying light conditions in terms of at least one of intensity, spectrum, polarization, directivity and timing of light and said variety-specific light protocol differently stimulating growth and/or improving the health of said multiple plant varieties, and said method may comprise controlling said light source according to a combination of said common light protocol and said variety-specific light protocol.

In this way, the problem of determining the custom light protocol may be deconstructed in two steps to make it easier to solve, especially if machine learning is not used. Improving the health of a plant may, for example, involve utilizing UV light to get rid of powdery mildew. Eliminating/minimizing powdery mildew means that the plant has better quality. UV light may however not improve the growth of the plant.

Said light source may be controlled according to said variety-specific light protocol at different moments than the moments at which said light source is controlled according to said common light protocol. This may provide better results in certain situations (e.g. certain combinations of plant varieties). In other situations, controlling the light source according to said variety-specific light protocol at the same moments at which said light source is controlled according to said common light protocol may provide better results. If the fastest growth is desired, it may be beneficial to do both.

Said method may comprise determining said variety-specific light protocol by combining said multiple light protocols associated with said multiple plant varieties, said multiple light protocols being combined by prioritizing a KPI of growth or plant properties for plants of a first plant variety of said multiple plant varieties over a KPI of growth or plant properties for plants of a second plant variety of said multiple plant varieties, said variety-specific light protocol sub optimally stimulating growth and/or improving the health of said second plant variety. The KPI (Key Performance Indicator) of growth or plant properties may comprise an indicator indicating the targeted harvest, for example. For instance, based on current growth stages and/or health states and inputted market demand per plant variety, it may be determined that the plants of the first plant variety need to grow faster and/or improve health faster than the plants of the second plant variety. For the prioritized plant variety, the actual harvesting moment may be closest to the target harvest moment. Examples of growth properties are harvest time, ripening speed, and vegetative growth.

Said method may comprise determining whether combining said multiple light protocols is estimated to result in a targeted KPI of plant growth or plant properties for said plants, and determining said variety-specific light protocol by combining said multiple light protocols if combining said multiple light protocols is estimated to result in said targeted KPI or determining said variety-specific light protocol by determining a single-variety-specific light protocol based on one of said light protocols associated with one of said multiple plant varieties if combining said multiple light protocols is estimated not to result in said targeted KPI. If combining the multiple light protocols does not result in a targeted KPI of plant growth or plant properties, it may be preferable to use a single-variety-specific light protocol.

Said method may comprise determining data representative of a spacing between said plants and a height of said plants and determining said custom light protocol further based on said data. This may be used to determine whether one plant blocks light to another plant. This may be taken into account when determining the custom light protocol.

Said custom light protocol may be determined based on one or more current growth stages or health states associated with said plants. This is beneficial when the optimal light settings differ between growth stages or health states. Furthermore, by determining the custom light protocol based on the one or more current growth stages or health states and one or more targeted KPIs of growth or plant properties, growth and/or health for a certain plant or group of plants may be accelerated or slowed down to achieve the targeted KPI(s).

Said custom light protocol may be determined based on a location of each of a plurality of plant pots, a location of said light source, a plant variety per plant pot, a current growth stage or health status per plant pot, and a targeted KPI of growth or plant properties per plant pot, each of said plants being planted in one of said plurality of plant pots. Typically, information associated with a plant pot specifies the corresponding plant variety. It is therefore convenient to track the plant varieties, the current growth stages or health states, and targeted KPIs per plant pot. Furthermore, the growth of a plant depends on the distance between the light source and the plant and may be affected when the light is (partly) blocked by a neighboring plant. It is therefore beneficial to determine the custom light protocol based on the location of the light source and the location per plant pot.

Said method may comprise determining a plurality of candidate light protocols based on said light protocols and/or said light sensitivities associated with each of said multiple plant varieties, determining the impact of each of said plurality of candidate light protocols on said targeted KPIs of growth or plant properties for said plants based on said current growth stages or health states, and determining said custom light protocol by selecting one of said plurality of candidate light protocols based on said targeted KPI. This may be beneficial, for example, when it is not possible to directly create an optimal custom light protocol based on information identifying the multiple plant varieties, the current growth stage(s) or health state(s), and the targeted KPI(s).

Said method may comprise determining a targeted KPI of growth or plant properties per current growth stage or health state associated with said plants, said targeted KPI comprising a target harvesting moment, each of said target harvesting moments falling in a harvesting stage of said corresponding plant variety, and said method may comprise determining said custom light protocol by inputting information identifying said multiple plant varieties, said one or more current growth stages or health states, and said one or more targeted harvesting moments per current growth stage or health state into a trained supervised or self-supervised learning model, said supervised or self-supervised learning model being trained to determine said custom light protocol based on said light sensitivities associated with each of said multiple plant varieties. Supervised and self-supervised learning provides a good way of learning light sensitivities and may be used to easily determine a custom light protocol. The supervised or self-supervised learning model may be trained to learn the optimal light duration per plant variety, for instance. A self-supervised learning model may cluster plants based on their variety and recognize if a previously unseen Cannabis strain is present in the lighting area, for example.

As an example, said trained supervised or self-supervised learning model may be trained with multiple training data instances to make said supervised or self-supervised learning model learn said light sensitivities, said multiple training data instances each indicating one or more plant varieties, one or more start growth stages or health states, an applied light protocol, one or more end growth stages or health states corresponding to each start growth stage, and an elapsed time.

Each of said multiple training data instances may comprise two captured images of one or more plants illuminated by a light source or two captured point clouds with sensor depth measurements performed in relation to said one or more plants and information which specifies said applied light protocol and said elapsed time between capturing said images or said point clouds. This allows the training data instances to be collected relatively easy and makes it easier to obtain a sufficient number of training data instances.

Said method may comprise obtaining constraints of said light source in terms of intensity, spectrum, polarization, directivity, and timing of light and said custom light protocol may further be determined based on said constraints. This may be used to avoid that a custom light protocol is determined which cannot be rendered well on the light source and to thereby determine a more optimal light protocol.

In a second aspect of the invention, a controller comprises one processor configured to identify multiple plant varieties of plants to be illuminated simultaneously by a light source, determine a custom light protocol for illuminating said plants of said multiple plant varieties under the same light conditions, based on light protocols and/or light sensitivities associated with each of said multiple plant varieties, said custom light protocol specifying light conditions in terms of at least one of intensity, spectrum, polarization, directivity and timing of light, and control said light source according to said custom light protocol.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling a light source in a plant growing environment.

The executable operations comprise identifying multiple plant varieties of plants to be illuminated simultaneously by a light source, determining a custom light protocol for illuminating said plants of said multiple plant varieties under the same light conditions, based on light protocols and/or light sensitivities associated with each of said multiple plant varieties, said custom light protocol specifying light conditions in terms of at least one of intensity, spectrum, polarization, directivity and timing of light, and controlling said light source according to said custom light protocol.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method;

FIG. 2 shows multiple plant varieties being illuminated simultaneously by a light source;

FIG. 3 is a flow diagram of a second embodiment of the method;

FIG. 4 is a flow diagram of a third embodiment of the method;

FIG. 5 is a flow diagram of a fourth embodiment of the method;

FIG. 6 is a flow diagram of a fifth embodiment of the method;

FIG. 7 is a flow diagram of a sixth embodiment of the method;

FIG. 8 is a flow diagram of a seventh embodiment of the method;

FIG. 9 is a flow diagram of an eighth embodiment of the method;

FIG. 10 is a block diagram of a first embodiment of the supervised or self-supervised learning model;

FIG. 11 is a block diagram of a second embodiment of the supervised or self-supervised learning model;

FIG. 12 is a block diagram of an embodiment of the controller; and

FIG. 13 is a block diagram of an exemplary data processing system for performing the method of the invention.

Corresponding elements in the drawings are denoted by the same reference numeral.

### DETAILED DESCRIPTION OF THE EMBODIMENTS

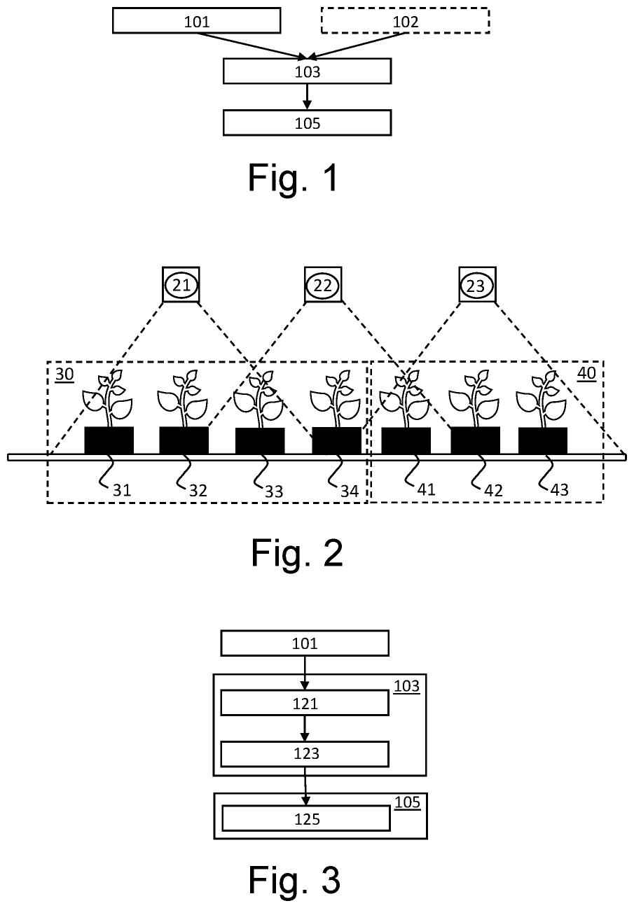

A first embodiment of the method of controlling a light source in a plant growing environment is shown in FIG. 1. The method may be performed by the computer 1 of FIG. 12, for example. A step 101 comprises identifying multiple plant varieties of plants to be illuminated simultaneously by a light source. The light source may comprise a single LED or multiple LEDs rendering the same light, for example. The multiple plant varieties may be identified based on sensor data, e.g. camera images, or based on user input, for example. The multiple plant varieties may include multiple varieties of the same plant species, e.g. multiple cultivars of Cannabis, and/or multiple varieties of different plant species.

Optionally, the method comprises a step 102. Step 102 comprises obtaining constraints of the light source in terms of intensity, spectrum, polarization, directivity, and timing of light. If step 102 is present, the obtained constraints are used in step 105.

A step 103 comprises determining a custom light protocol for illuminating the plants of the multiple plant varieties under the same light conditions, based on light protocols and/or light sensitivities associated with each of the multiple plant varieties. The custom light protocol specifies light conditions in terms of at least one of intensity, spectrum, polarization, directivity and timing of light. In a first implementation, the custom light protocol is determined based on light protocols associated with each of the multiple plant varieties and information on plant sensitivities in general, e.g. of a certain plant species.

In a second implementation, the custom light protocol is determined by first selecting light protocols associated with each of the multiple plant varieties and then combining the selected light protocols based on the light sensitivities associated with each of the multiple plant varieties. In a third implementation, the custom light protocol is determined based on the light sensitivities associated with each of the multiple plant varieties without selecting any plant-specific light protocols, e.g. by using machine learning.

The custom light protocol may further be determined based on one or more current growth stages or health states associated with the plants and/or based on KPIs of growth or plant properties, e.g. based on the market demand for each plant variety, e.g. Cannabis cultivar, to be harvested in the future. For example, in the above-mentioned first and second implementations, the light protocols (or a part thereof) may be selected in a first step based on the one or more current growth stages or health states associated with the plants and the market demand for each plant variety. Thus, in this example, the light protocols are selected based on whether growth or the health for a certain plant or group of plants needs to be accelerated or slowed down.

In a second step, the light sensitivities of the multiple plant varieties, of plants in general, or of one or more plant species in general are taken into account for this light source, which will illuminate plants of the multiple plant varieties simultaneously. This results in a custom light protocol which satisfies both plant varieties according to a well-chosen trade-off between the well-being of the multiple plant varieties.

Preferably, this custom light protocol takes into account when and which of the plant varieties is scheduled to be harvested. For instance, if a first plant variety is harvested first but the second plant variety stays behind on the grow shelf, suddenly the occlusion and thereby the received light will completely change for the second plant variety.

If the method comprises step 102, the custom light protocol is further determined in step 103 based on the constraints obtained in step 102. For example, an initial custom light protocol may be determined based on the light protocols and/or the light sensitivities associated with each of the multiple plant varieties and this initial custom light protocol may then be mapped to the actual hardware and software capabilities (intensity, spectrum, polarization, directivity, and/or timing of light) of the light source to obtain a final custom light protocol.

A step 105 comprises controlling the light source according to the custom light protocol determined in step 103. If no light source constraints are obtained, e.g. if step 102 is not present, images of the light source may be captured while the light source is controlled according to the custom light protocol. These images may be analyzed in real-time to determine whether the light protocol can actually be rendered by the light source. If the light protocol cannot be rendered by the light source, the light protocol may be adjusted or, if step 102 is present, the learned constraints of the light source may be stored such that they can be used a next time. Additionally, one or more steps of one or more of the embodiments of FIGS. 3 to 9 may be added to the embodiment of FIG. 1.

FIG. 2 shows multiple plant varieties being illuminated simultaneously by a light source. FIG. 2 shows three light sources 21, 22, and 23. These light sources may comprise LEDs or light sources of another type. Light source 21 illuminates plants 31-33, light source 22 illuminates plants 33, 34, and 41, and light source 23 illuminates plants 41-43. Plants 31-34 are of a first plant variety 30 and plants 41-43 are of a second plant variety 40. In the example of FIG. 2, plants 31-34 and plants 41-43 are included in the same grow shelf. Light source 21 illuminates plants of a single plant variety, i.e. plant variety 30. It is therefore trivial to select a light protocol associated with this plant variety 30 and control the light source 21 according to this light protocol.

Light sources 22 and 23 both illuminate plants of two plant varieties, i.e. plant varieties 30 and 40, which makes it non-trivial to determine a corresponding light protocol. The boundary between a first plant section with plants of plant variety 30 and a second plant section with plants of plant variety 40 is not aligned with the light boundary between the first light distribution of the light source 22 and the second light distribution of the light source 23. The method of FIG. 1 can be used to determine a custom light protocol for each of light sources 22 and 23 and control them accordingly. The light sources 22 and 23 are controlled differently than the light source 21 and light source 23 may optionally be controlled differently than light source 22.

In the example of FIG. 2, the horticulture installation uses top lighting in which the light is emitted in perpendicular direction relative to the grow shelf (to save space in the green house). Sometimes inter-lighting fixtures are used for illuminating plants under an angle. However, inter-lighting is typically only used for selectively administering brighter illumination on the fruits hanging well below the top of the plant canopy. Inter-lighting fixtures are not shown in FIG. 2.

In the example of FIG. 2, two plant sections are shown. Each plant section comprises only plants of the same plant variety which were planted at the same time. It may also happen that a single light source not only simultaneously illuminates plants of multiple plant varieties but also simultaneously illuminates multiple plant sections with plants of the same plant variety (but different current growth stages and/or health states per plant section). This is not shown in FIG. 2.

A second embodiment of the method of controlling a light source in a plant growing environment is shown in FIG. 3. The method may be performed by the computer 1 of FIG. 12, for example. The second embodiment of FIG. 3 is an extension of the first embodiment of FIG. 1. In the embodiment of FIG. 3, step 103 of FIG. 1 is implemented by steps 121 and 123 and step 105 of FIG. 1 is implemented by a step 125.

Step 121 comprises determining a common light protocol based on each of the light protocols and/or light sensitivities associated with the multiple plant varieties. The common light protocol specifies light conditions in terms of at least one of intensity, spectrum, polarization, directivity and timing of light. The common light protocol stimulates growth of all of the multiple plant varieties.

Step 123 comprises determining a variety-specific light protocol based on at least one of the light protocols associated with the multiple plant varieties. The variety-specific light protocol specifies light conditions in terms of at least one of intensity, spectrum, polarization, directivity and timing of light. The variety-specific light protocol differently stimulates growth of the multiple plant varieties. Thus, the custom light protocol comprises a common part and a variety-specific part. The common part is preferably maximally variety independent and hence may be uniformly administered to all the plants (independent of variety).

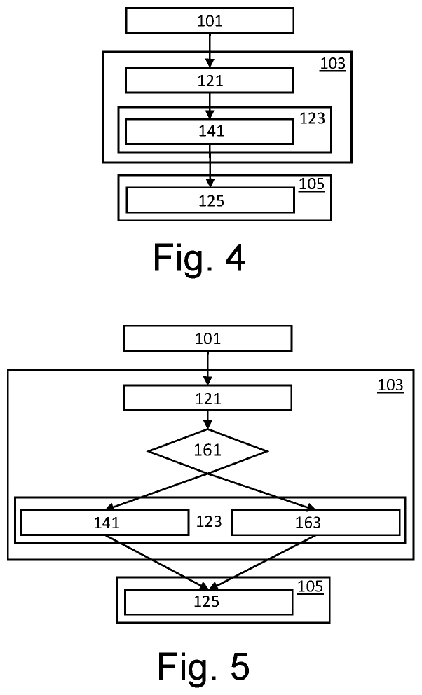

Step 125 comprises controlling the light source according to a combination of the common light protocol determined in step 121 and the variety-specific light protocol determined in step 123. Optionally, the light source is controlled according to the variety-specific light protocol at different moments than the moments at which the light source is controlled according to the common light protocol. Additionally, one or more steps of the embodiment of FIG. 4 or of the embodiment of FIG. 5 may be added to the embodiment of FIG. 3.

A third embodiment of the method of controlling a light source in a plant growing environment is shown in FIG. 4. The method may be performed by the computer 1 of FIG. 12, for example. The third embodiment of FIG. 4 is an extension of the second embodiment of FIG. 3. In the embodiment of FIG. 4, step 123 of FIG. 3 is implemented by a step 141.

In step 141, a variety-specific light protocol is determined by combining the multiple light protocols associated with the multiple plant varieties. The variety-specific protocol is obtained by prioritizing a KPI of growth or plant properties for plants of a first plant variety of the multiple plant varieties over a KPI of growth or plant properties for plants of a second plant variety of the multiple plant varieties. The variety-specific light protocol sub optimally stimulates growth of the second plant variety.

Examples of growth properties are harvest time, ripening speed, and vegetative growth. The KPI of growth or plant properties may comprise an indicator indicating the targeted harvest, for example. For example, based on the current growth stages and inputted market demand per plant variety, it may be determined that the plants of the first plant variety need to grow faster than the plants of the second plant variety. For the prioritized plant variety, the actual harvesting moment may be closest to the target harvest moment.

A fourth embodiment of the method of controlling a light source in a plant growing environment is shown in FIG. 5. The method may be performed by the computer 1 of FIG. 12, for example. The fourth embodiment of FIG. 5 is an extension of the second embodiment of FIG. 3.

After the common light protocol, i.e. the common part of the custom light protocol, has been determined in step 121 (see FIG. 3), a step 161 is performed. Step 161 comprises determining whether combining the multiple light protocols is estimated to result in a targeted KPI of plant growth or plant properties for the plants. Step 141 of FIG. 4 is performed if it is determined in step 161 that combining the multiple light protocols is estimated to result in the targeted KPI. A step 163 is performed if it is determined in step 161 that combining the multiple light protocols is estimated not to result in the targeted KPI.

Step 141 comprises determining the variety-specific light protocol by combining the multiple light protocols, as described in relation to FIG. 4. Step 163 comprises determining the variety-specific light protocol by determining a single-variety-specific light protocol based on one of the light protocols associated with one of the multiple plant varieties. For example, in step 163, the plant variety which needs to grow fastest may be selected based on the current growth stages and inputted market demand per plant variety and the light protocol associated with this plant variety may then be selected as variety-specific light protocol. Additionally or alternatively, the plant variety whose health needs to improve fastest may be selected based one or more current health states per plant variety and inputted market demand per plant variety. Step 125 is performed after step 141 or step 163 has been performed.

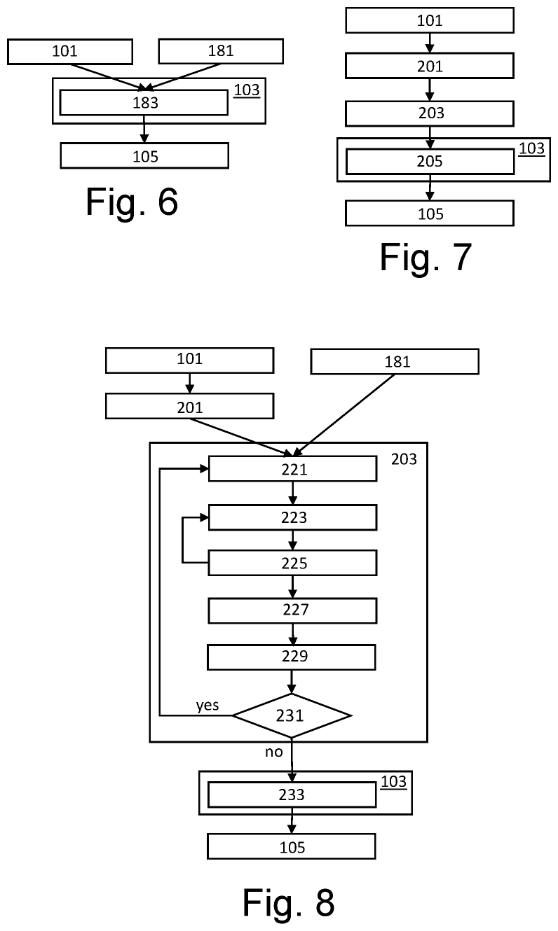

A fifth embodiment of the method of controlling a light source in a plant growing environment is shown in FIG. 6. The method may be performed by the computer 1 of FIG. 12, for example. The fifth embodiment of FIG. 6 is an extension of the first embodiment of FIG. 1. In the embodiment of FIG. 6, step 103 of FIG. 1 is implemented by a step 183 and a step 181 is performed (in addition to step 101) before step 183.

Step 181 comprises determining data representative of a spacing between the plants (illuminated by the light source) and a height of the plants. The spacing between the plants and further plants neighboring the plants may also be determined in step 181. Step 183 comprises determining the custom light protocol based on the light protocols and/or the light sensitivities associated with each of the multiple plant varieties and further based on the data determined in step 181.

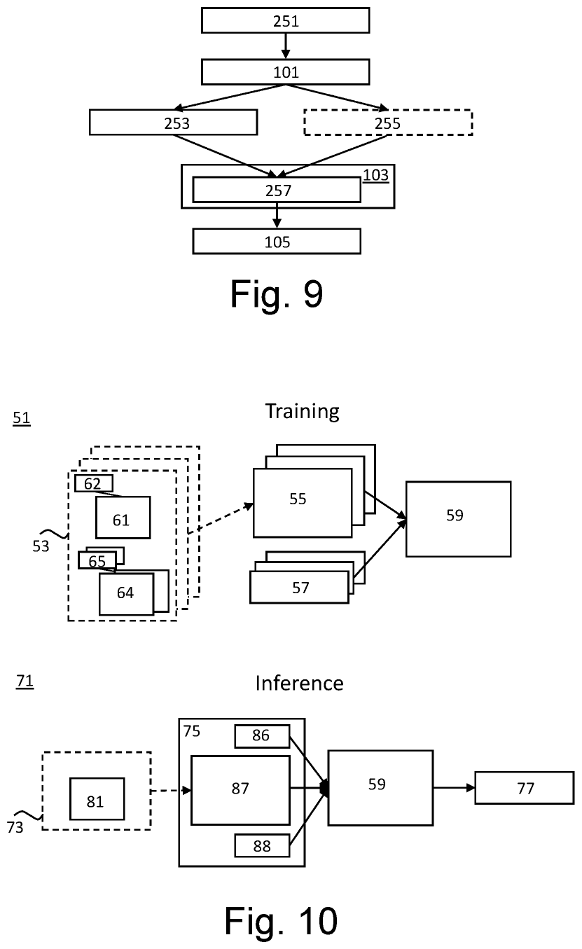

In step 183, it may be determined, for example, that a first plant of a first plant variety occludes a second plant of a second plant variety and that the growth of the first plant should be slowed down to ensure that the neighboring second plant will receive sufficient grow light to also flourish. The plants'full growth trajectory until harvest may be taken into account for each of the different plant varieties to determine the best possible multi-variety light protocol. Additionally, one or more steps of one or more of the embodiments of FIGS. 7 and 8 or of the embodiment of FIG. 9 may be added to the embodiment of FIG. 6.

A sixth embodiment of the method of controlling a light source in a plant growing environment is shown in FIG. 7. The method may be performed by the computer 1 of FIG. 12, for example. The sixth embodiment of FIG. 7 is an extension of the first embodiment of FIG. 1. In the embodiment of FIG. 7, step 103 of FIG. 1 is implemented by a step 205 and steps 201 and 203 are performed between steps 101 and 205.

Step 201 comprises determining a plurality of candidate light protocols based on the light protocols and/or the light sensitivities associated with each of the multiple plant varieties identified in step 101. Step 203 comprises determining the impact of each of the plurality of candidate light protocols on targeted KPIs of growth or plant properties (for the plants to be illuminated simultaneously by the light source) based on the current growth stages or health states associated with the plants.

The targeted KPIs and the current growth stages or health states may be obtained in one or more steps not shown in FIG. 7, for example. Step 205 comprises determining the custom light protocol by selecting one of the plurality of candidate light protocols, as determined in step 201, based on the impact of each of the plurality of candidate light protocols on the targeted KPIs, as determined in step 203. Additionally, one or more steps of the embodiment of FIG. 8 may be added to the embodiment of FIG. 7.

A seventh embodiment of the method of controlling a light source in a plant growing environment is shown in FIG. 8. The method may be performed by the computer 1 of FIG. 12, for example. The seventh embodiment of FIG. 8 is an extension of both the fifth embodiment of FIG. 6 and the sixth embodiment of FIG. 7.

Step 101 comprises identifying multiple plant varieties of plants to be illuminated simultaneously by a light source. Step 201 comprises determining a plurality of candidate light protocols based on the light protocols and/or the light sensitivities associated with each of the multiple plant varieties identified in step 101, see FIG. 7. Step 181 comprises determining data representative of a spacing between the plants and a height of the plants, see FIG. 6. Step 181 may comprise identifying the one or more virtual boundaries between the plant sections illuminated by the light source, including the one or more virtual boundaries between plant varieties.

Next, step 203 is performed. Step 203 comprises determining the impact of each of the plurality of candidate light protocols, as determined in step 201, on a targeted KPIs of growth or plant properties for the plants based on the current growth stages or health states associated with the plants, see FIG. 7.

In the embodiment of FIG. 8, step 203 is implemented by steps 221-231. In the first iteration of step 221, step 221 comprises selecting a first candidate light protocol from the plurality of candidate light protocols. Step 223 comprises determining characteristics of light received at different surface locations of the plants, if the candidate light protocol selected in the current iteration of step 221 would be applied, based on this candidate light protocol, the locations of the plants with respect to the location of a light source, and the space determined or estimated to be occupied by the plants in step 181 or in the most recent iteration of step 225, whichever was performed last.

Step 225 comprises determining predictions of the changes in space occupied by the plants, compared to the space determined or estimated to be occupied by the plants in step 181 or in the previous iteration of step 225 (whichever was performed last), based on the plant variety per plant, the current growth stage or health state per plant, and the characteristics of light received at the different surface locations of the plants, as determined in step 223.

In steps 223 and 225, 3D growth of each plant is forecast and the impact on their light reception is estimated as a function of their canopies. This growth typically differs per plant variety. In other words, it is determined how the plants of the multiple plant varieties are growing over time and how at any given moment the growth trajectory of plants of one plant variety affects the growth trajectory of plants of another plant variety. As genetically each plant variety's growth rate varies between plant varieties and the grow parameters are different for each plant, the flowers of different plant varieties will have different shape, size, and weight. Administering different light protocols would result in a different occlusion of the plants over time and hence create a different 3D lighting distribution over time within the grow shelf (even if the light generation of the light source(s) would remain constant).

Steps 223 and 225 are repeated until all plants have reached the harvesting stage. Step 227 is performed next after all plants have reached the harvesting stage. Step 227 comprises estimating an achieved performance, e.g. estimating a harvesting moment per plant, if the candidate light protocol selected in the current iteration of step 221 would be applied, based on the predictions of the changes in space occupied by the plants, as determined in step 225. Step 229 comprises determining a difference between the achieved performance estimated in step 227 and the targeted KPI.

Step 231 comprises checking whether all candidate light protocols have been selected in step 221. If so, step 103 is performed next. If not, the next candidate light protocol is selected next in step 221 and steps 223-229 are repeated for this next candidate light protocol.

Step 103 comprises determining a custom light protocol for illuminating the plants of the multiple plant varieties under the same light conditions, based on light protocols and/or light sensitivities associated with each of the multiple plant varieties. The custom light protocol specifies light conditions in terms of at least one of intensity, spectrum, polarization, directivity and timing of light.

In the embodiment of FIG. 8, Step 103 is implemented by a step 233. Step 233 combines step 183 of FIG. 6 and step 205 of FIG. 7. Step 205 comprises determining the custom light protocol by selecting one of the plurality of candidate light protocols based on the differences determined in step 229, e.g. by selecting the candidate light protocol in which all KPIs, e.g. KPIs per plant or per plant section, are met. Thus, in step 233, the light protocol may be chosen in consideration of how this choice will affect the grow trajectory of the multiple plant varieties and in particular the resulting occlusion effects by the leaves of the multiple plant varieties. Step 105 comprises controlling the light source according to the custom light protocol determined in step 103.

An eight embodiment of the method of controlling a light source in a plant growing environment is shown in FIG. 9. The method may be performed by the computer 1 of FIG. 12, for example. The eighth embodiment of FIG. 9 is an extension of the first embodiment of FIG. 1.

A step 251 comprises identifying plants to be illuminated simultaneously by a light source. The plants are of multiple plant varieties. Step 101 comprises identifying the multiple plant varieties, e.g. based on the results of step 251. A step 253 comprises determining a targeted KPI of growth or plant properties per current growth stage or health state and per plant variety (i.e. per plant section). This targeted KPI comprises a target harvesting moment. Each of the target harvesting moments falls in a harvesting stage of the corresponding plant variety. The targeted KPI may be determined per current growth stage or health state without determining the current growth stage or health state. For example, a grower may input a target harvesting moment relative to the current moment. An optional step 255 comprises determining the one or more current growth stages associated with the plants. This information is used in a first variant of a first implementation of this embodiment, for example.

Step 103 comprises determining a custom light protocol for illuminating the plants of the multiple plant varieties under the same light conditions, based on light protocols and/or light sensitivities associated with each of the multiple plant varieties. The custom light protocol specifies light conditions in terms of at least one of intensity, spectrum, polarization, directivity and timing of light. Step 105 comprises controlling the light source according to the custom light protocol determined in step 103.

In the embodiment of FIG. 9, step 103 is implemented by a step 257. Step 257 comprises inputting information, identifying the multiple plant varieties, one or more current growth stages, and one or more targeted harvesting moments per current growth stage into a trained supervised or self-supervised learning model. The supervised or self-supervised learning model has been trained to determine the custom light protocol based on the light sensitivities associated with each of the multiple plant varieties. The one or more targeted harvesting moments per current growth stage may be specified in a schedule and task description that describes when and to which extent each plant variety will be clipped/de-leafed in the future. In an alternative embodiment, one or more current health states may be alternatively or additionally identified in the inputted information.

Optionally, the custom light protocol is determined in step 257 based on a location of each of a plurality of plant pots, a location of the light source, a plant variety per plant pot, a current growth stage per plant pot, and a targeted KPI of growth or plant properties per plant pot. For example, the information inputted in step 257 may identify a plant variety, a current growth stage, and a targeted harvesting moment per plant pot and may further identify a location of the light source and a location per plant pot. The latter is beneficial, as the growth of a plant depends on the distance between the light source and the plant and may be affected when the light is (partly) blocked by a neighboring plant. Each of the plants to be illuminated by the light source is planted in one of these plant pots.

In the first implementation of this embodiment, the trained supervised or self-supervised learning model has been trained with multiple training data instances, to make the supervised or self-supervised learning model learn the light sensitivities. The multiple training data instances each indicate one or more plant varieties, one or more start growth stages, an applied light protocol, one or more end growth stages corresponding to each start growth stage, and an elapsed time. In unsupervised learning, the applied light protocol may be omitted.

The elapsed time may be specified as the relative day passed after entering into the growth stage (e.g., propagation, vegetative, and flowering) plus the time. This way, plants of propagation start date/time+1 of batch #1 are compared against those of propagation start date/time+1 of batch #2. As many plants in different batches come from the same mother plants (meaning that they have same genotype), they show similar growth patterns over the growth periods.

In this first implementation, the information inputted into the trained supervised or self-supervised learning model identifies the one or more current growth stages per plant variety as one or more start growth stages per plant variety and identifies the one or more target harvesting moments per plant variety and current growth stage by identifying a harvesting stage as end growth stage for each of the multiple plant varieties and identifying, per plant variety and current growth stage, a target time difference between the current growth stage and the harvesting stage of the plant variety.

In the first variant of this first implementation, a supervised learning model is used and the inputs to the supervised learning model all comprise only letters and/or numerals. FIG. 10 shows a block diagram of this first variant. In the training phase 51, training data instances are fed to a supervised learning model 59, e.g. a (deep) neural network. Each training data instance comprises an input-output pair. This input-output pair comprises training input 55 and corresponding training output 57. The training input 55 comprises letters and/or numerals indicative of A. one or more plant varieties, B. two or more growth stages per plant section (each plant section comprising only plants of the same plant variety which were planted at the same time), and C. the elapsed time between each two growth stages. A growth stage may be specified as a percentage (100% being the harvesting stage) or as a growth stage identifier, for example. The corresponding training output 57 comprises letters and/or numerals indicating the applied light protocol.

The training input 55 may have been manually entered or may have been automatically determined from sensor data 53. Each training input 55 may be determined from multiple captured images of one or more plants illuminated by a light source or from multiple captured point clouds with sensor depth measurements performed in relation to the one or more plants, e.g. from images or point clouds 61 and 64, and from metadata which specify the times at which the images or point clouds 61 and 64 were captured, e.g. from timestamps 62 and 65. The images or point clouds 61 and 64 may be visible images (e.g. from an RGB camera) or 3D point clouds from a structured light sensor, for example.

In the inference phase 71, input 75 is fed into the supervised learning model 59, which then provides output 77 as a result. The output 77 comprises letters and/or numerals indicating the light protocol to be applied. The input 75 comprises letters and/or numerals indicating A. multiple plant varieties, B. multiple growth stages per plant section, including the current growth stage per plant section and the harvesting stage per plant section, and C. the target time difference between the current growth stage and the harvesting stage per plant section.

FIG. 10 shows that input 75 comprises three parts 86-88. The input itself does not need to distinguish between these parts. Part 86 indicates the harvesting stage per plant section, part 87 indicates the multiple plant varieties and the current growth stage per plant section, and part 88 indicates the target time difference between current growth stage and harvesting stage per plant section.

Part 87 (the multiple plant varieties and the current growth stage per plant section) may be entered manually or may be determined automatically from very recently captured sensor data 73, i.e. from image or point cloud 81. The grower may input the target time difference per plant section (part 88) manually, for example. The grower may determine the target time difference based on market demand, for example. Part 86 (the harvesting stage) may be indicated with a growth stage identifier identifying the harvesting stage or with a percentage (e.g. 100%), for example.

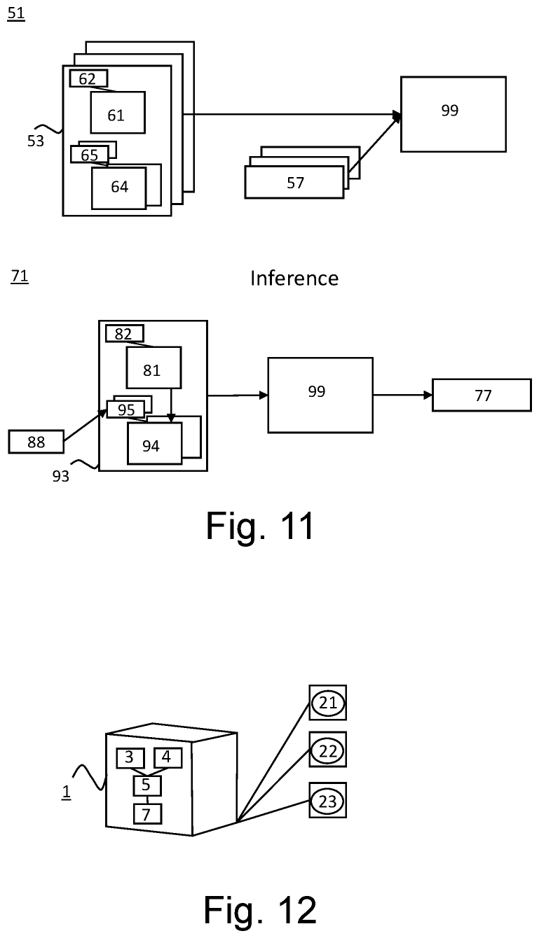

In a second variant of the first implementation, the inputs to the trained supervised learning model comprise images or point clouds. FIG. 11 shows a block diagram of this second variant. In the training phase 51, training data instances are fed to a supervised learning model 99, e.g. a (deep) neural network. Each training data instance comprises an input-output pair.

In this second variant, the input-output pair comprises sensor data 53 (see FIG. 10) as training input and corresponding training output 57 (see also FIG. 10). Thus, in this variant, the sensor data 53 is fed directly into the supervised learning model 99 and the sensor data 53 is not pre-processed like shown in FIG. 10. This will require more training data instances to be provided to the supervised learning model 99 in order to train it. In a third variant, both the sensor data 53 and training input 55, which is derived partly from the sensor data 53, are fed into the supervised learning model 99.

In the inference phase 71, input 93 is fed into the supervised learning model 99, which then provides output 77 as a result. The output 77 comprises letters and/or numerals indicating the light protocol to be applied. The input 93 comprises a very recently captured image or point cloud 81 and metadata 82 (a time stamp) indicating the time at which this image or point cloud was captured (e.g. the current time). The input 93 further comprises one or more further images or point clouds 94. Each of the one or more further images or point clouds represents at least one of the multiple plant varieties in the harvesting stage.

For example, each of the plant sections is represented in the harvesting stage in a different one of the further images and each of the further images is associated with metadata 95 indicative of the target time difference between the current growth stage and the harvesting stage of the corresponding plant section (e.g. this target time difference can be determined based on the metadata 95 and the metadata 82). These further images may be generated automatically based on information which identifies the plant variety per plant section. Other plant sections may be left blank in these generated images. The metadata associated 95 with the further images, e.g. timestamps, may be created based on information 88 indicative of a target time difference per plant section inputted manually by the grower, for example. The grower may determine the target time difference based on market demand, for example.

FIG. 12 shows an embodiment of the system for controlling a light source in a plant growing environment. In the embodiment of FIG. 12, the system is a computer 1. The computer 1 comprises a receiver 3, a transmitter 4, a processor 5, and a memory 7. The processor 5 may be adapted to execute one of the methods shown in FIG. 1 and FIGS. 3 to 9. The computer 1 is able to control light sources 21-23.

The processor 5 is configured to identify, e.g. via the receiver 3, multiple plant varieties of plants to be illuminated simultaneously by a light source 22, determine a custom light protocol for illuminating the plants of the multiple plant varieties under the same light conditions based on light protocols and/or light sensitivities associated with each of the multiple plant varieties, and control, e.g. via the transmitter 4, the light source 22 according to the custom light protocol. The custom light protocol specifies light conditions in terms of at least one of intensity, spectrum, polarization, directivity and timing of light.

In the embodiment of the computer 1 shown in FIG. 12, the computer 1 comprises one processor 5. In an alternative embodiment, the computer 1 comprises multiple processors. The processor 5 of the computer 1 may be a general-purpose processor, e.g. from Intel or AMD, or an application-specific processor. The processor 5 of the computer 1 may run a Windows or Unix-based operating system for example. The memory 7 may comprise one or more memory units. The memory 7 may comprise one or more hard disks and/or solid-state memory, for example. The memory 7 may be used to store an operating system, applications and application data, for example.

The receiver 3 and the transmitter 4 may use one or more wired and/or wireless communication technologies such as Ethernet and/or Wi-Fi (IEEE 802.11) to communicate with the light sources 21-23, for example. In an alternative embodiment, multiple receivers and/or multiple transmitters are used instead of a single receiver and a single transmitter. In the embodiment shown in FIG. 12, a separate receiver and a separate transmitter are used. In an alternative embodiment, the receiver 3 and the transmitter 4 are combined into a transceiver. The computer 1 may comprise other components typical for a computer such as a power connector.

The invention may be implemented using a computer program running on one or more processors. In the embodiment of FIG. 12, the controller is a device. In another embodiment, the controller is a component of a device.

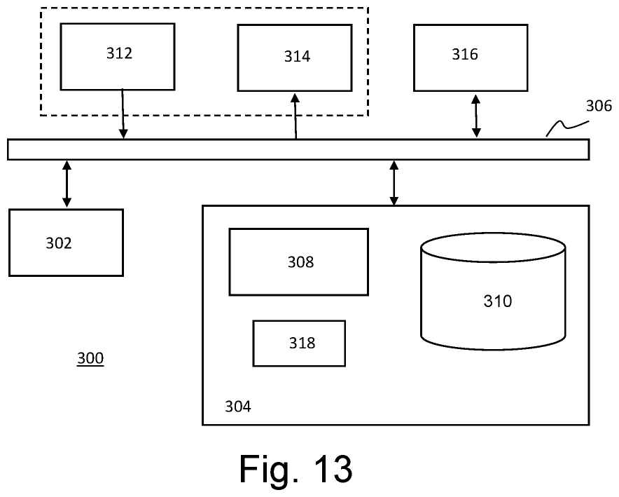

FIG. 13 depicts a block diagram illustrating an exemplary data processing system that may perform the method as described with reference to FIG. 1 and FIGS. 3 to 9.

As shown in FIG. 13, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g., for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 13 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 13, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 13) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of controlling a light source in a plant growing environment, said method comprising;
identifying multiple plant varieties of plants to be illuminated simultaneously by a light source,
determining a custom light protocol for illuminating said plants of said multiple plant varieties under the same light conditions, based on light protocols and/or light sensitivities associated with each of said multiple plant varieties, said custom light protocol specifying light conditions in terms of at least one of intensity, spectrum, polarization, directivity and timing of light, and
controlling said light source according to said custom light protocol.

2. A method as claimed in claim 1, wherein said method comprises determining said custom light protocol by:
determining a common light protocol based on each of said light protocols and/or light sensitivities associated with said multiple plant varieties, said common light protocol specifying light conditions in terms of at least one of intensity, spectrum, polarization, directivity and timing of light and said common light protocol stimulating growth and/or improving the health of all of said multiple plant varieties; and
determining a variety-specific light protocol based on at least one of said light protocols associated with said multiple plant varieties, said variety-specific light protocol specifying light conditions in terms of at least one of intensity, spectrum, polarization, directivity and timing of light and said variety-specific light protocol differently stimulating growth and/or improving the health of said multiple plant varieties,
said method comprising
controlling said light source according to a combination of said common light protocol and said variety-specific light protocol.

3. A method as claimed in claim 2, wherein said light source is controlled according to said variety-specific light protocol at different moments than the moments at which said light source is controlled according to said common light protocol.

4. A method as claimed in claim 2, wherein said method comprises determining said variety-specific light protocol by combining said multiple light protocols associated with said multiple plant varieties, said multiple light protocols being combined by prioritizing a KPI of growth or plant properties for plants of a first plant variety of said multiple plant varieties over a KPI of growth or plant properties for plants of a second plant variety of said multiple plant varieties, said variety-specific light protocol sub optimally stimulating growth and/or improving the health of said second plant variety.

5. A method as claimed in claim 2, wherein said method comprises:
determining whether combining said multiple light protocols is estimated to result in a targeted KPI of plant growth or plant properties for said plants; and
determining said variety-specific light protocol by combining said multiple light protocols if combining said multiple light protocols is estimated to result in said targeted KPI; or
determining said variety-specific light protocol by determining a single-variety-specific light protocol based on one of said light protocols associated with one of said multiple plant varieties if combining said multiple light protocols is estimated not to result in said targeted KPI.

6. A method as claimed in claim 1, wherein said method comprises:
determining data representative of a spacing between said plants and a height of said plants, and
determining said custom light protocol further based on said data.

7. A method as claimed in claim 1, wherein said custom light protocol is determined based on one or more current growth stages or health states associated with said plants.

8. A method as claimed in claim 1, wherein said custom light protocol is determined based on a location of each of a plurality of plant pots, a location of said light source, a plant variety per plant pot, a current growth stage or health state per plant pot, and a targeted KPI of growth or plant properties per plant pot, each of said plants being planted in one of said plurality of plant pots.

9. A method as claimed in claim 1, wherein said method comprises:
determining a plurality of candidate light protocols based on said light protocols and/or said light sensitivities associated with each of said multiple plant varieties,
determining the impact of each of said plurality of candidate light protocols on a targeted KPI of growth or plant properties for said plants based on said current growth stages or health states, and
determining said custom light protocol by selecting one of said plurality of candidate light protocols based on said targeted KPI.

10. A method as claimed in claim 1, wherein said method comprises determining a targeted KPI of growth or plant properties per current growth stage or health state associated with said plants, said targeted KPI comprising a target harvesting moment, each of said target harvesting moments falling in a harvesting stage of said corresponding plant variety, and wherein said method comprises determining said custom light protocol by inputting information identifying said multiple plant varieties, said one or more current growth stages or health states, and said one or more targeted harvesting moments per current growth stage or health state into a trained supervised or self-supervised learning model (59,99), said supervised or self-supervised learning model being trained to determine said custom light protocol based on said light sensitivities associated with each of said multiple plant varieties.

11. A method as claimed in claim 10, wherein said trained supervised or self-supervised learning model has been trained with multiple training data instances, to make said supervised or self-supervised learning model learn said light sensitivities, said multiple training data instances each indicating one or more plant varieties, one or more start growth stages or health states, an applied light protocol, one or more end growth stages or health states corresponding to each start growth stage or health state, and an elapsed time.

12. A method as claimed in claim 11, wherein each of said multiple training data instances comprises two captured images of one or more plants illuminated by a light source or two captured point clouds with sensor depth measurements performed in relation to said one or more plants and information which specifies said applied light protocol and said elapsed time between capturing said images or said point clouds.

13. A method as claimed in claim 1, wherein said method comprises obtaining constraints of said light source in terms of intensity, spectrum, polarization, directivity, and timing of light and wherein said custom light protocol is further determined based on said constraints.

14. A controller (1) comprising at least one processor (5) adapted to execute claim 1.

15. A computer program or suite of computer programs comprising at least one software code portion or a computer program product storing at least one software code portion, the software code portion, when run on the at least one processor of the controller of claim 14, being configured for performing claim 1.
